(19) United States
(12) Patent Application Publication
(10) Pub. No.: US 2026/0019121 A1
(43) Pub. Date: Jan. 15, 2026

(54) REPORTING DESIGN FOR DOPPLER DOMAIN CHANNEL STATE INFORMATION

(71) Applicant: QUALCOMM Incorporated, San Diego, CA (US)

(72) Inventors: Liangming WU, Beijing (CN); Jing DAI, Beijing (CN); Chao WEI, Beijing (CN); Wei XI, Beijing (CN); Min HUANG, Beijing (CN); Chenxi HAO, Beijing (CN); Rui HU, Beijing (CN); Hao XU, Beijing (CN); Wanshi CHEN, San Diego, CA (US)

(21) Appl. No.: 18/992,542

(22) PCT Filed: Aug. 8, 2022
(86) PCT No.: PCT/CN2022/110745

§ 371 Date: Jan. 8, 2025

(51) Int. Cl. H04B 7/06

(52) U.S. Cl. CPC H04B 7/0626; H04B 7/0632

(57) ABSTRACT

Certain aspects of the present disclosure provide a method for wireless communication by a user equipment (UE). generally including receiving. from a network entity. a configuration for Doppler domain channel state information (CSI) reporting. measuring channel state information (CSI) based on a bundle of CSI reference signal (CSI-RS) occasions, and transmitting. in accordance with the configuration. a report for Doppler domain CSI that includes parameters that indicate time domain variations of the measured CSI.

### BACKGROUND

### Field of the Disclosure

Aspects of the present disclosure relate to wireless communications, and more particularly, to techniques for reporting Doppler domain channel state information (CSI).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a user equipment (UE). The method includes receiving, from a network entity, a configuration for Doppler domain channel state information (CSI) reporting; measuring CSI based on a bundle of CSI reference signal (CSI-RS) occasions; and transmitting, in accordance with the configuration, a report for Doppler domain CSI that includes parameters that indicate time domain variations of the measured CSI.

Another aspect provides a method of wireless communications by a network entity. The method includes transmitting a configuration for Doppler domain CSI reporting by a UE; transmitting a bundle of CSI-RS on a bundle of CSI-RS occasions; and receiving, in accordance with the configuration, a report for Doppler domain CSI that includes parameters that indicate time domain variations of the measured CSI.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts information extrapolated by a user equipment (UE) based on UE observations.

FIG. 6 depicts example alternative timelines for CSI measurement and CSI reporting.

FIG. 7 depicts a call flow for Doppler domain CSI reporting, in accordance with aspects of the present disclosure.

FIG. 8 depicts one example mechanism for indicating CQI variations in time.

FIG. 9 depicts another example mechanism for indicating CQI variations in time.

FIG. 10 depicts yet another example mechanism for indicating CQI variations in time.

FIG. 11A, FIG. 11B, and FIG. 11C illustrate example parameters for determining a time domain CQI grid.

FIG. 12 depicts a method for wireless communications.

FIG. 13 depicts a method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for reporting Doppler domain channel state information (CSI). As will be described below, a user equipment (UE) may be configured to report Doppler CSI with parameters indicating variations of measured CSI over time.

In current wireless communication systems, channel state information (CSI) reporting allows a UE to measure the quality of a variety of radio channels and report the results to a network entity. In some cases, CSI compression may be utilized to limit signaling overhead. In such cases, some linear combination of spatial, frequency, and time domain as a basis may be used to perform channel compression and information extrapolation based on UE observations.

In one case, a UE may report channel measurement values extrapolated from actual observed CSI measurements based on multiple CSI reference signal (CSI-RS) occurrences. This allows a UE to respond to multiple CSI-RS occurrences within a single report, reducing power consumption and conserving transmission resources. However, certain extrapolated measurement information transmitted in the CSI report may fail to account for changes in channel quality resulting from a variety of conditions.

Aspects of the present disclosure provide techniques that allow a UE to account for differences between observed and extrapolated information and report those differences to the network entity. For example, the UE may transmit, to a network entity, a CSI report having a wideband channel quality indicator (CQI) and one or more subband differential CQI values. The differential CQI values may reflect CQI changes occurring in the time domain, the frequency domain, or both. By applying techniques described herein, the UE may continue to benefit from the power saving effect of CSI report bundling while maintaining the accuracy of extrapolated information. The network entity may use the more accurate extrapolated information to improve network scheduling.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

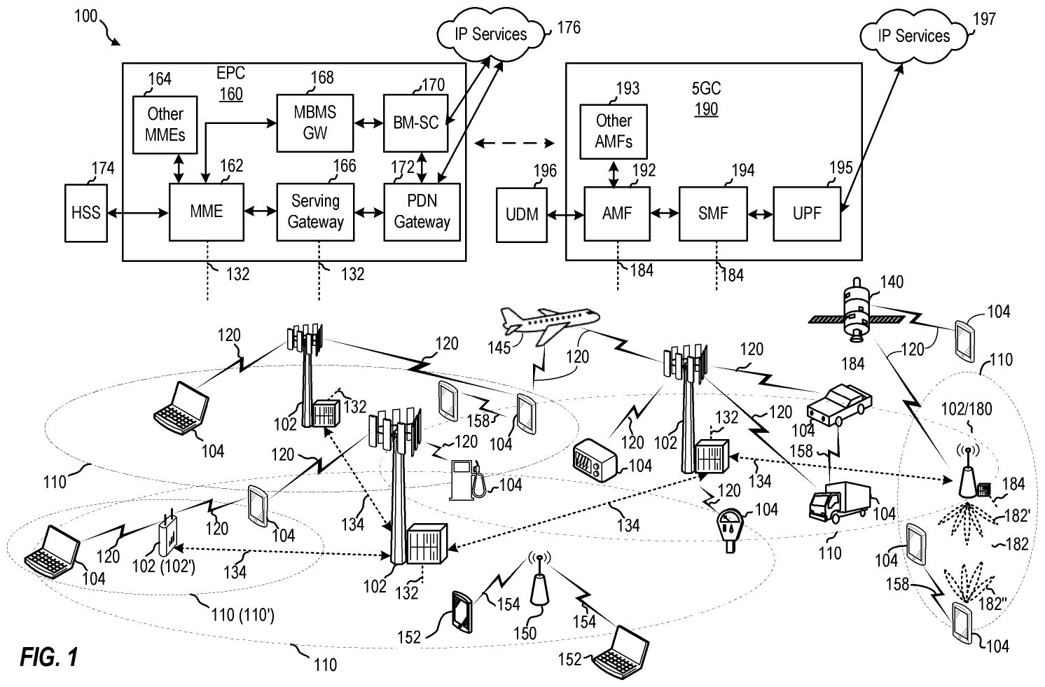

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

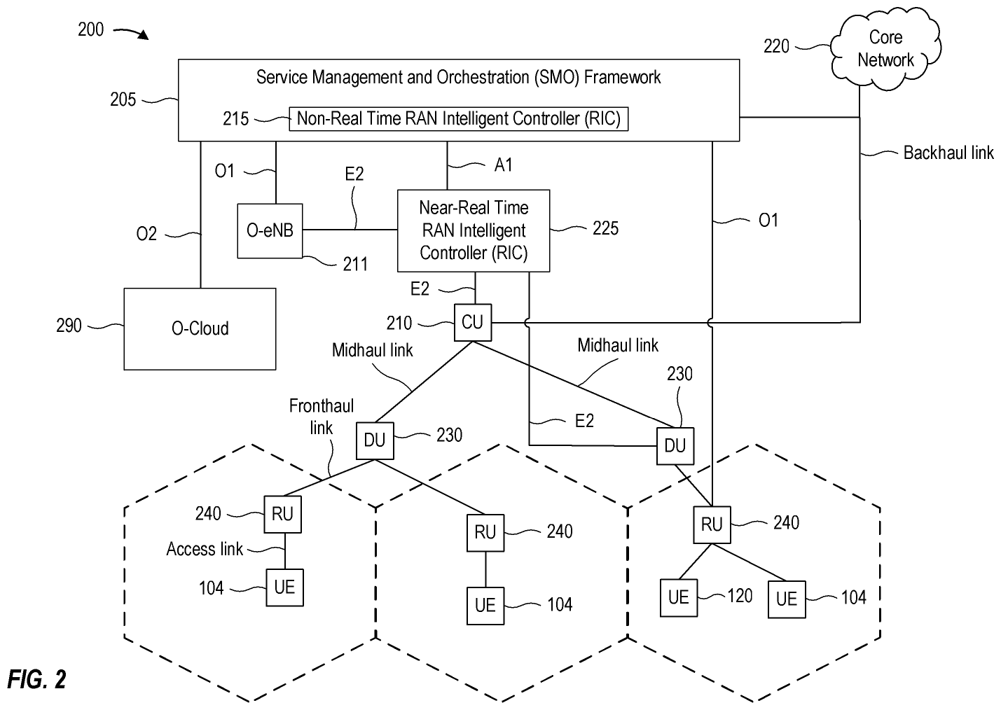

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′ BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

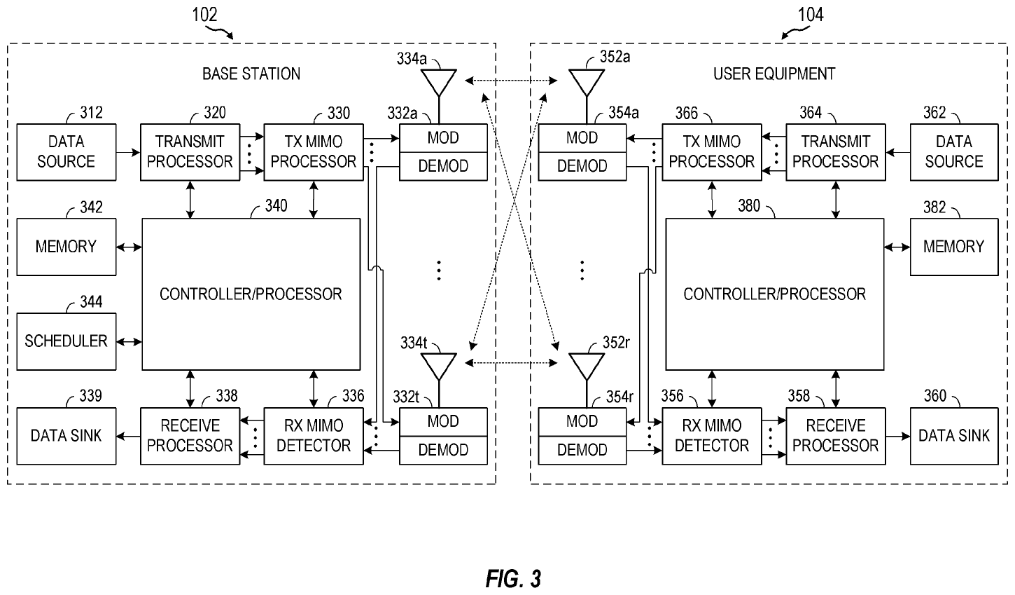

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

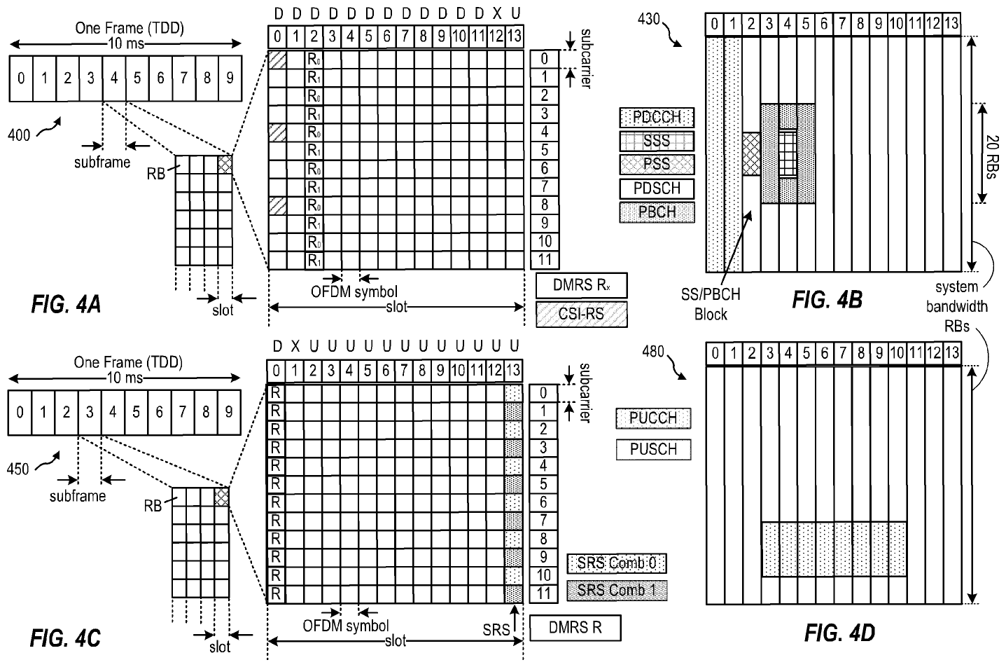

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 24×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Doppler Domain CSI Reporting

Channel state information (CSI) reporting is a mechanism by which a UE is able to measure the quality of a variety of radio channels and report the results to a network entity (e.g., BS 102 depicted and described with respect to FIGS. 1 and 3 or a disaggregated base station depicted and described with respect to FIG. 2). CSI in NR includes a variety of channel quality metrics, such as Channel Quality Indicator (CQI); Precoding Matrix Indicator (PMI), CSI-RS Resource Indicator (CRI), Strongest Layer Indication (SLI), Rank Indication (RI), and L1-RSRP (for beam management).

Certain channel quality metrics may be sent utilizing a codebook. In a CSI reference signal (RS) context, a codebook generally refers to a set of precoders (e.g., one or more PMIs). In certain wireless systems (e.g., 5G wireless systems), Type-I and Type-II codebooks are supported. For MIMO systems, Type-II codebook utilization allows a UE to provide a detailed CSI report to network entity to optimize beamforming and beam selection during wireless communication.

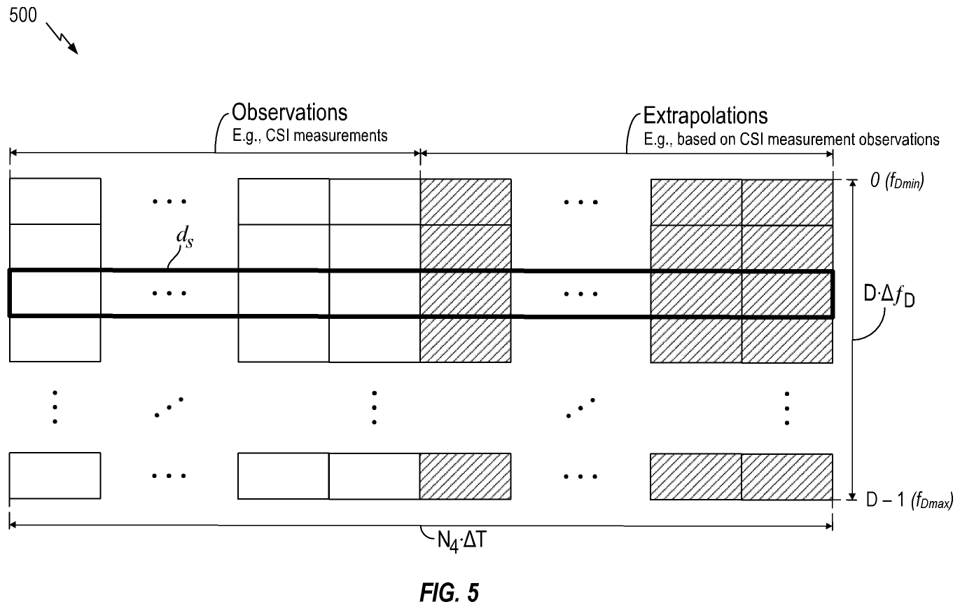

As noted above, in current wireless systems, the content of CSI reporting by a UE may be compressed for transmission. Various spatial, frequency, and time domain CSI compression schemes may be utilized. In certain cases (e.g., the CSI measurement and reporting discussed with respect to FIG. 5), some linear combination of spatial, frequency, and time domain as a basis may be used to perform channel compression and extrapolation based on UE observations.

Certain compression schemes do not utilize time domain (TD) compression. For example, Type II CSI has spatial domain (SD) and frequency domain (FD) compression. For example, at time instance n, the precoder for a certain layer on subbands designated N₃ may be written as:

$$W = {W}_{1} \times {\tilde{W}}_{2} \times {W}_{f}^{H} = ( \begin{matrix}{\sum }_{i = 0}^{L - 1} {\sum }_{m = 0}^{M - 1} {v}_{{m}_{1}^{( i )} , {m}_{2}^{( i )}} {c}_{i , m} \cdot {f}_{{m}_{3}^{( m )}}^{H} \\ {\sum }_{i = 0}^{L - 1} {\sum }_{m = 0}^{M - 1} {v}_{{m}_{1}^{( i )} , {m}_{2}^{( i )}} {c}_{i + 2 L , m} \cdot {f}_{{m}_{3}^{( m )}}^{H}\end{matrix} ) ,$$

where c_{i,m,l} is equivalent to the combination coefficient for the “i-th” spatial basis (e.g., the beam), and the “m-th” frequency basis. \tilde{W}₂ is the 2L×M matrix containing all coefficients.

$${v}_{{m}_{1}^{( i )} , {m}_{2}^{( i )}}$$

is a Nₜ×1 SD basis. W₁ is a Nₜ×2L matrix containing all SD bases

$${f}_{{m}_{3}^{( m )}}^{H}$$

is a 1×N₃ FD basis.

$${W}_{f}^{H}$$

is a M×N₃ matrix containing all FD bases. In this example, time instance index n is omitted for brevity. The CSI report may be independent for each CSI occasion.

In some cases, each coefficient may be modelled in a CSI report of a CSI reference signal (RS) occasion n. In other words, \tilde{W}₂(n) as described above may be a band-limited process matrix. The process may be described by the following equation:

$${c}_{i , m} ( n ) = {\tilde{c}}_{i , m} ( n ) = {\sum }_{τ = 0}^{D - 1} {d}_{τ} ( n ) \cdot {γ}_{τ , i , m}$$

where d_{τ}(n) represents the TD or Doppler basis. γ_{τ,i,m} is the combination coefficient for the τ-th time basis, the i-th spatial basis (e.g., the beam), and the m-th frequency basis.

A UE may measure and report γ_{τ,i,m} based on a certain number, N, of bundled CSI-RS occurrences. The UE may also measure and report W₁ and W_{f} as described above. The W₁ and W_{f} matrix may be assumed invariant across the N bundled CSI-RS occasions.

In many cases, a UE may utilize a discrete Fourier transform (DFT) based time-domain codebook. The benefits of a DFT-time domain codebook are similar to SD/FD bases used to reduce potential standard efforts. The DFT bases introduce flexible modelling that allow a UE to produce “non-flat” and “non-symmetric” Doppler spectrum models. The structure e^{j2πft} may be used for infinite extension and/or extrapolation as illustrated in FIG. 5.

A UE utilizing the DFT bases may use observations (e.g., CSI channel measurements) and extrapolate based on those observations (e.g., extrapolating CSI from observed CSI measurements). In FIG. 5, subtime

$$Δ T = \frac{1}{{f}_{Dmax} - {f}_{Dmin}} = \frac{1}{D Δ {f}_{D}}$$

represents the maximum Doppler range. Here, subtime size ΔT may be defined at a slot-level (e.g., 4 slots (500 Hz Doppler range for 30 kHz SCS)). Time-domain size N₄ may be defined where N₄≥N_{ob}. The size of the Doppler basis set, D, may be greater than N₄ for non-orthogonal DFT basis with superior Doppler resolution (e.g. Δf_D=10 Hz). D may be defined as oversampling D=N₄·O₄. In FIG. 5, dₛ may be defined according to the following equation:

$$\begin{matrix}{d}_{s} = {[ 1 , {e}^{j 2 π \frac{s}{D}} , … , {e}^{j 2 π \frac{s ( {N}_{4} - 1 )}{D}} ]}^{T} , s = 0 , 1 , … , D - 1 \\ = {[ 1 , {e}^{j 2 π \frac{s}{{N}_{4} {O}_{4}}} , … , {e}^{j 2 π \frac{s ( {N}_{4} - 1 )}{{N}_{4} {O}_{4}}} ]}^{T}\end{matrix}$$

Type-II codebook based CSI reporting may be refined for high/medium velocities. In these cases, a CSI report may be defined for a slot n. A length of a Doppler domain (DD) and/or time domain (TD) basis vector be N₄. The basis vector may have no span or window in time-domain. A CSI-RS measurement window may be defined as [k,k+Wₘₑₐₛ−l], representing the window in which CSI-RS occasion(s) are measured for calculating a CSI report. In this example, k is a slot index and Wₘₑₐₛ is the measurement window length, l, in slots. In certain wireless systems (e.g., Rel-16/17), the CSI-RS occasion(s) are configured in a CSI report configuration information element (e.g., CSI-ReportConfig).

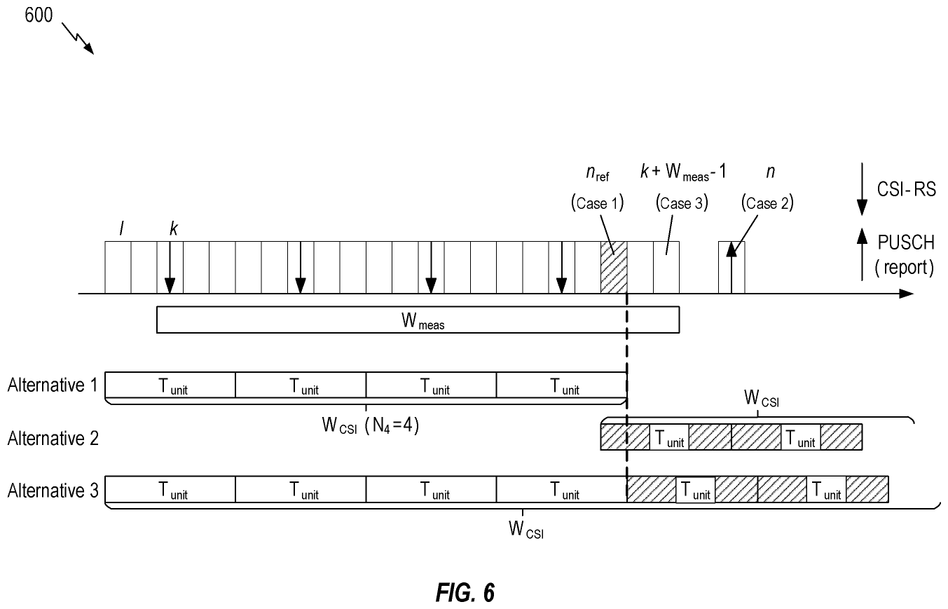

FIG. 6 illustrates an example CSI measurement window as it overlaps with a CSI reporting window in three different cases, shown as Alternatives 1, 2, and 3. A CSI reporting window of [l,l+W_{CSI}−l] is associated with the CSI report in slot n. l is a slot index and W_{CSI} is the reporting window length in slots. The location of a CSI reference resource is denoted as n_{ref} (slot index). In the first case, n_{ref} may be defined as a boundary. In Alternative 1, l+W_{CSI}−1≤n_{ref} . . . In Alternative 2, l≥n_{ref}. In Alternative 3, l<n_{ref} and l+W_{CSI}−l>n_{ref}.

In a second case, report slot n may be defined as a boundary. Alternatives 1-3 may apply for a second case.

In a third case, the end slot of Wₘₑₐₛ may be defined as a boundary. For example, a boundary may be defined as an end slot where l+W_{CSI}−l≤k+Wmeas−l. Here, the following special rule may apply: l=k, W_{CSI}=Wₘₑₐₛ.

For example, a boundary may be defined as an end slot where either l≥k+Wₘₑₐₛ−l, or l<k+Wₘₑₐₛ−l and l+W_{CSI}−l>k+Wₘₑₐₛ−l with the following as special cases: l=k, l+W_{CSI}=n, and l=k, 1+W_{CSI}>n.

The first, second and third cases described above may differentiate a slot defined as the boundary of past observations and future predictions or extrapolations. The first alternatives for each case are observation-only boundaries, where CSI measurement and CSI reporting windows coincide in time as illustrated in Alternative 1 of FIG. 6. The second alternatives for each case are prediction-only boundaries, where a CSI reporting window occurs substantially after the CSI measurement window as illustrated in Alternative 2 of FIG. 6. The third alternatives for each case are observation-plus-prediction boundaries, where a CSI reporting window coincides with and continues after the CSI measurement window as illustrated in Alternative 3 of FIG. 6.

According to certain aspects of the present disclosure, for one-instance CQI reporting, the UE may report a wideband channel quality indicator (CQI) and one or more subband differential CQI values to a network entity. For Doppler domain CSI reporting, the CQI may reflect the CQI variation in timing to improve network entity scheduling. For example, the UE may apply a suitable scheduling modulation and coding scheme (MCS) based on statistics from a CQI.

In this manner, aspects of the present disclosure provide CQI reporting that accounts for both frequency and time domain variation. Aspects of the present disclosure provide various mechanisms for how to construct CQI index values, CQI_{f,t}, that are based on differential variation caused by frequency and time variation (e.g., those caused by Doppler conditions). Reported instances of CQI (e.g., which f, t are reported) may be associated with a CSI-RS for measurement.

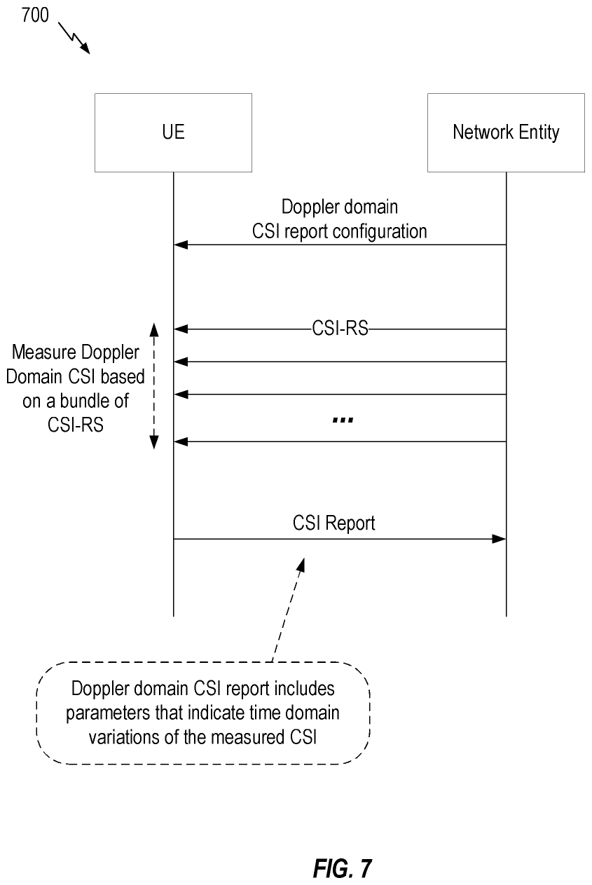

Doppler CSI reporting according to aspects of the present disclosure may be understood with reference to the example call flow diagram 700 of FIG. 7. The call flow diagram depicts signaling between a network entity and a UE. In some aspects, the network entity may be an example of the BS 102 depicted and described with respect to FIGS. 1 and 3 or a disaggregated base station depicted and described with respect to FIG. 2. Similarly, the UE may be an example of UE 104 depicted and described with respect to FIGS. 1 and 3. However, in other aspects, UE 104 may be another type of wireless communications device and BS 102 may be another type of network entity or network node, such as those described herein.

As illustrated in FIG. 7, the UE may first receive, from the network entity, a Doppler domain CSI report configuration. Based on the configuration, the UE measures Doppler domain CSI based on a bundle of CSI-RS occasions. The UE may then transmit a Doppler domain CSI report to the network entity that includes parameters that indicate time domain variations of the measured CSI.

There are various options for how to construct the parameters that indicate time domain variations of measured CSI.

For example, according to a first option, a CSI report may contain a bundled CQI value, C̅Q̅I̅, which is the average of all CQI in the bundled CSI report. Each time and frequency CQI index, CQI_{f,t} is provided with a differential CQI term, which may defined according to the following equation:

$${CQI}_{f , t} = \overline{CQI} + {Δ}_{f , t}$$

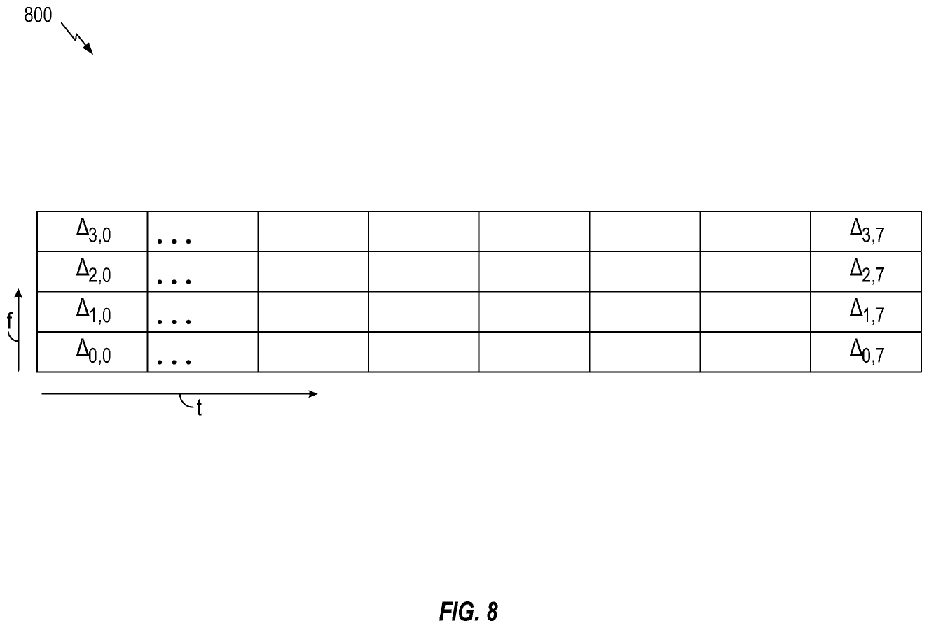

In this case, a different Δ_{f,t} may be defined for each different combination of f and/CQI index values. FIG. 8 illustrates the differential term Δ_{f,t} as applied across each CQI index within a time block. The illustrated example shows terms for four frequency indices (0-3) and 7 time indices (0-7).

According to another option, the UE may report differential CQI information in the time domain report. The reference time block wideband CQI may be reported asCQIₜ_{_{ref}}. The reference block subband CQI may be reported with a first differential term, which may be varied across different CQI index values and may be defined according to the following equation:

$${CQI}_{f , {t}_{ref}} = {CQI}_{{t}_{ref}} + {Δ}_{f , {t}_{ref}}$$

In a first example, the UE may assign a different Δ_{f,t}_{_{ref}} value for each of value. The UE may also report a subband CQI with a second differential term, which may be defined according to the following equation:

$${CQI}_{f , t} = {CQI}_{f , t - 1} + {δ}_{t} .$$

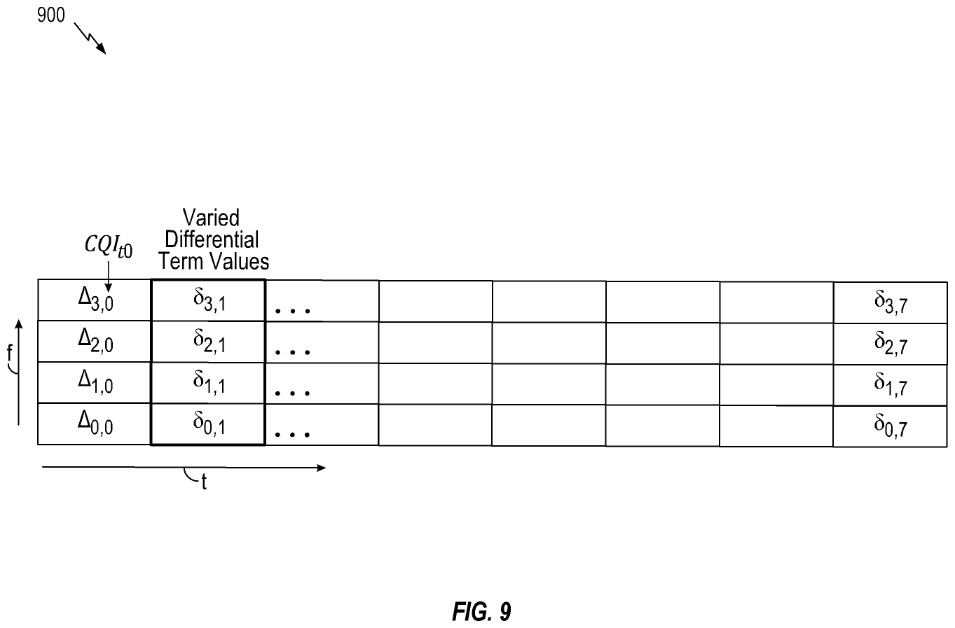

In this case, each different f and t CQI index values are greater than or equal to 1. Quantization bits for Δ_{f,t0} to and δ_{f,t} may be different. FIG. 9 illustrates the first differential term Δ_{f,t} and the second differential term δ_{f,t} as applied across each CQI index within a time block.

In a second example, the UE may report subband CQI with a second differential term, which may be defined according to the following equation:

$${CQI}_{f , t} = {CQI}_{f , t - 1} + {δ}_{t} .$$

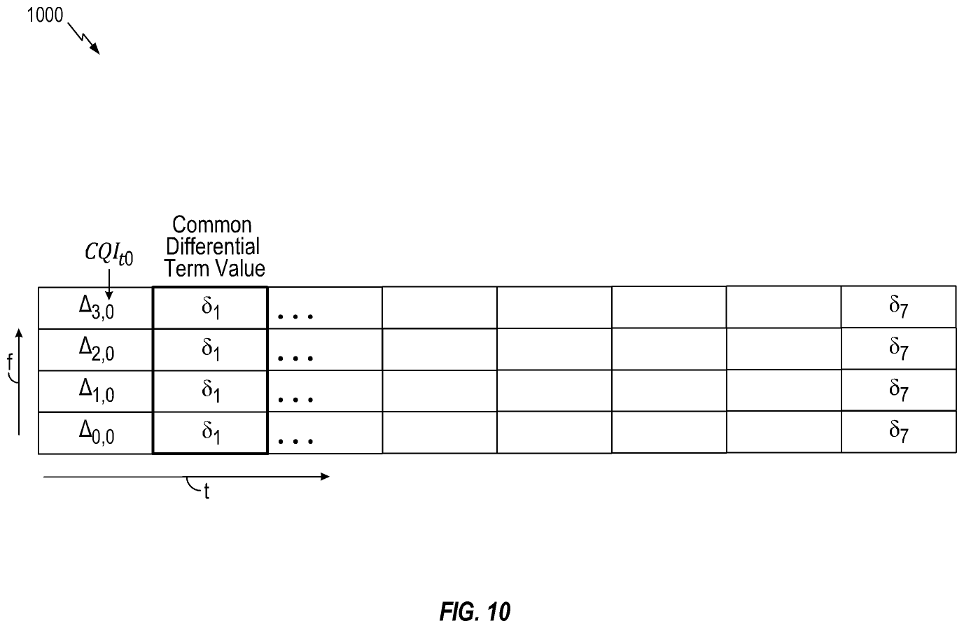

In this case, a common δₜ value is shared for each different f and t CQI index values greater than or equal to 1. Quantization bits for Δ_{f,t0} and δ_{f,t} may be different. FIG. 10 illustrates the first differential term Δ_{f,t} and the second differential term δₜ as applied across each CQI index within a time block.

Certain conditions may be defined to determine a time domain CQI grid. The reporting time grid size of CQI may be specified (e.g., as a sub-time). This reporting may be similar to frequency domain subband reporting with a subband size defined. N_{CQI_subtime} may be defined for generating the grid length of time domain bundling CQI. N_{CQI_subtime} may be proportional to the pre-coding matrix indicator (PMI) subtime granularity. This proportionality may be maintained by determining N_{CQI_subtime} based on N_{PMI_subtime} and a parameter, K, and may be defined according to the following equation:

$${N}_{CQI \_ subtime} = K \cdot {N}_{PMI \_ subtime} .$$

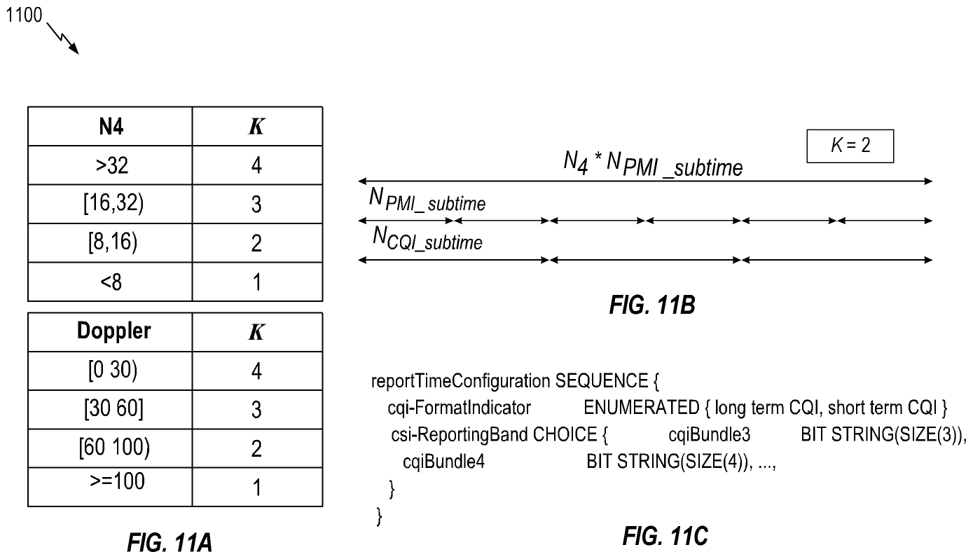

In one example illustrated in FIG. 11B, where K=2, N_{QCI_subtime} may be equivalent to N_{PMI_subtime} scaled to a factor of 2. In another example, where K=1, N_{CQI_subtime} may be equivalent to N_{PMI_subtime} scaled to a factor of 1. Here, N_{PMI_gran} represents PMI granularity in the time domain. In some cases, the total number of reported CQI bundles may be equivalent to ┌N₄/K┐, where N₄ is a total number of samples. The length of time for reporting each of the samples may be equivalent to N₄*N_{PMI_subtime}.

N_{CQI_subtime} may be configured via a network entity (e.g., gNB), or reported by a UE based on its Doppler conditions. For different Doppler frequencies, the number of bundled time slots may be different. The parameter K as illustrated in FIG. 11A may be associated with N₄, (N₄, O₄), or a configured Doppler range.

In some cases, a joint configuration of subband size and K may be supported. A report time bundle (e.g., similar to reportFreqConfiguration in current NR releases) may be defined. Additionally, a modification of the current reportFreqConfiguration may be made to support both frequency and time domain definitions of CQI. In one example, the parameterN₄, (N₄, O₄), or Doppler information may be configured by a network entity, which is used in both temporal basis determination and N_{CQI_subtime} determination. This may be configured in parallel with subband size within the CSI report configuration. An indication of the selected CQI time instance (e.g., reportTimeConfiguration) may also be supported (e.g., similar to reportFreqConfiguration in current NR releases).

Example pseudo-code for reportTimeConfiguration is illustrated in FIG. 11C. The CQI time instance may contain a CQI format indicator (e.g., cqi-FormatIndicator), a CSI reporting band (e.g., cqi-ReportingBand), and/or a CQI bundle indicator (e.g., cqiBundle4).

In certain cases, a UE may take action based on whether or not CQI falls within a defined measurement time. In such cases, a Doppler CSI report may include Doppler domain CSI with a first resolution when the report is transmitted within the CSI-RS measurement time or the Doppler CSI report may include Doppler domain CSI with a second resolution when the report is transmitted within the CSI-RS measurement time. The first resolution may correspond to subband CQI in the report, while the second resolution may correspond to wideband CQI in the report.

For example, the UE may consider whether all of a CSI report falls within the CSI-RS measurement time (e.g., Alternative 1 of FIG. 6), whether all of a CSI report falls outside of the CSI-RS measurement time (e.g., Alternative 2 of FIG. 6), or whether a CSI report is not restricted to fall completely in or completely out of CSI-RS measurement time (e.g., Alternative 3 of FIG. 6). To account for this consideration, the associated CQI design may fit the report CSI window.

In general, the feedback resolution associated with different part of CSI window may be different. For example, for the CSI with CSI-RS measurement, subband CQI may be supported. For the CSI out of CSI-RS measurement, wideband CQI may be supported. Other methods are not precluded, such as CQI quantization bits for differential CQI varied according to different CSI parts.

### Example Operations of a User Equipment

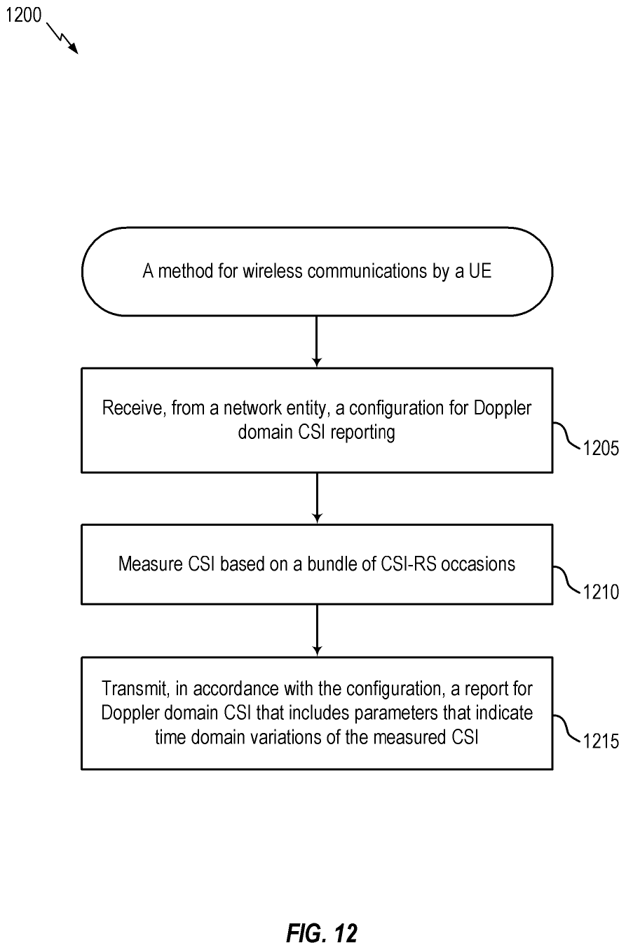

FIG. 12 shows an example of a method 1200 for wireless communications by a UE, such as UE 104 of FIGS. 1 and 3.

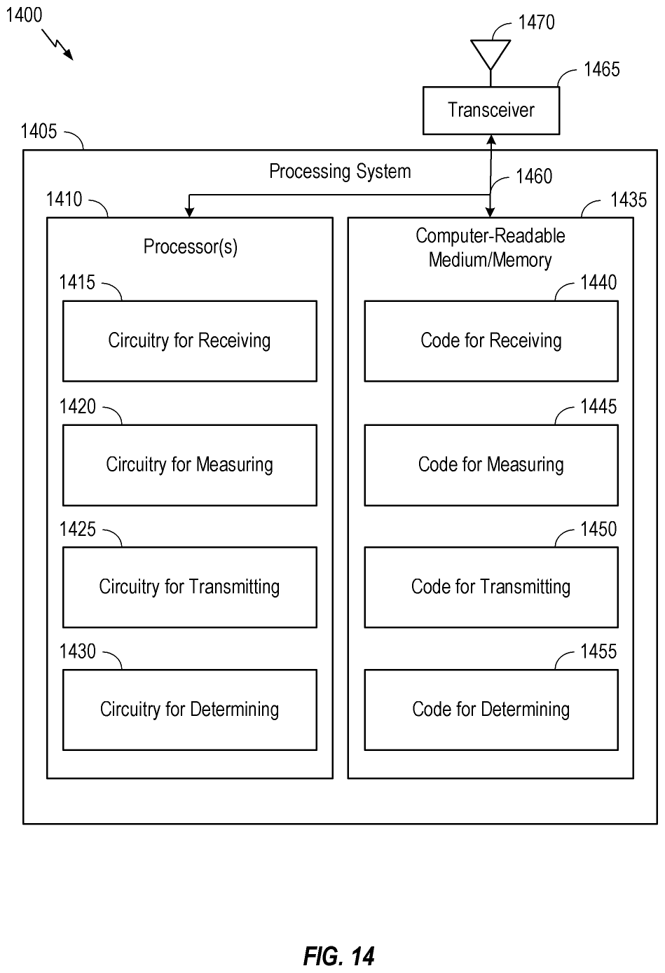

Method 1200 begins at step 1205 with receiving, from a network entity, a configuration for Doppler domain CSI reporting. In some cases, the operations of this step refer to, or may be performed by, circuitry for receiving and/or code for receiving as described with reference to FIG. 14.

Method 1200 then proceeds to step 1210 with measuring CSI based on a bundle of CSI-RS occasions. In some cases, the operations of this step refer to, or may be performed by, circuitry for measuring and/or code for measuring as described with reference to FIG. 14.

Method 1200 then proceeds to step 1215 with transmitting, in accordance with the configuration, a report for Doppler domain CSI that includes parameters that indicate time domain variations of the measured CSI. In some cases, the operations of this step refer to, or may be performed by, circuitry for transmitting and/or code for transmitting as described with reference to FIG. 14.

In some aspects, the report parameters also indicate frequency domain variation of the measured.

In some aspects, the report also indicates the CSI-RS occasions that were measured and on which the report is based.

In some aspects, the report indicates: an average CQI that is an average of CQI calculated individually for the bundled CSI-RS occasions; and for each time and frequency CQI index associated with the report, a differential CQI term.

In some aspects, the differential CQI term represents a difference between the average CQI and a CQI calculated for the corresponding time and frequency CQI index.

In some aspects, the report indicates: a reference time block wideband CQI calculated for a reference time index; for each frequency CQI index associated with the report, a reference block subband CQI calculated based on the reference time block wideband CQI and a first differential term; and for each time CQI index associated with the report, a time block subband CQI calculated based on a block subband CQI and a second differential term.

In some aspects, the first differential term, for a corresponding frequency index, represents a difference between the reference time block wideband CQI and a CQI calculated for the reference time index and the corresponding frequency index.

In some aspects, the second differential term, for a corresponding frequency index and time index, represents a difference between a time block subband CQI calculated for the corresponding frequency index and a previous time index.

In some aspects, the UE calculates different second differential terms for different frequency indexes.

In some aspects, the UE calculates a common second differential term for different frequency indexes.

In some aspects, the method 1200 further includes determining a time grid size for reporting the Doppler domain CSI. In some cases, the operations of this step refer to, or may be performed by, circuitry for determining and/or code for determining as described with reference to FIG. 14.

In some aspects, the time grid size is determined based on a scaling factor and a parameter for generating the time grid size for time domain bundling CQI.

In some aspects, at least one of the scaling factor or parameter is configured by the network entity.

In some aspects, at least one of the scaling factor or parameter is reported by the UE to the network entity.

In some aspects, the configuration indicates whether the report is to be transmitted within a CSI-RS measurement time.

In some aspects, the report includes Doppler domain CSI with a first resolution when the report is transmitted within the CSI-RS measurement time; or the report includes Doppler domain CSI with a second resolution when the report is transmitted within the CSI-RS measurement time.

In some aspects, the first resolution corresponds to subband CQI in the report; and the second resolution corresponds to wideband CQI in the report.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Operations of a Network Entity

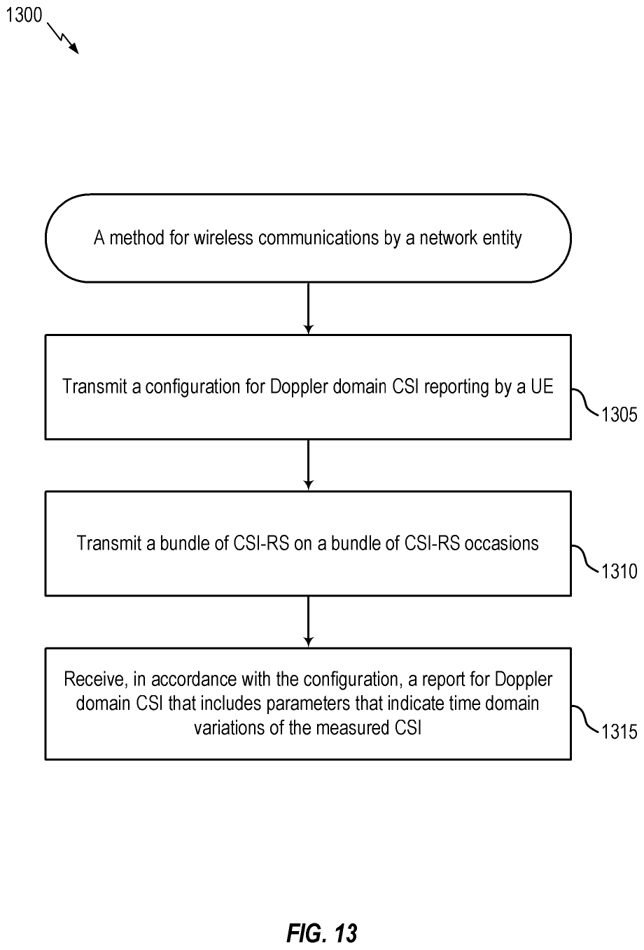

FIG. 13 shows an example of a method 1300 for wireless communications by a network entity, such as BS 102 of FIGS. 1 and 3, or a disaggregated base station as discussed with respect to FIG. 2.

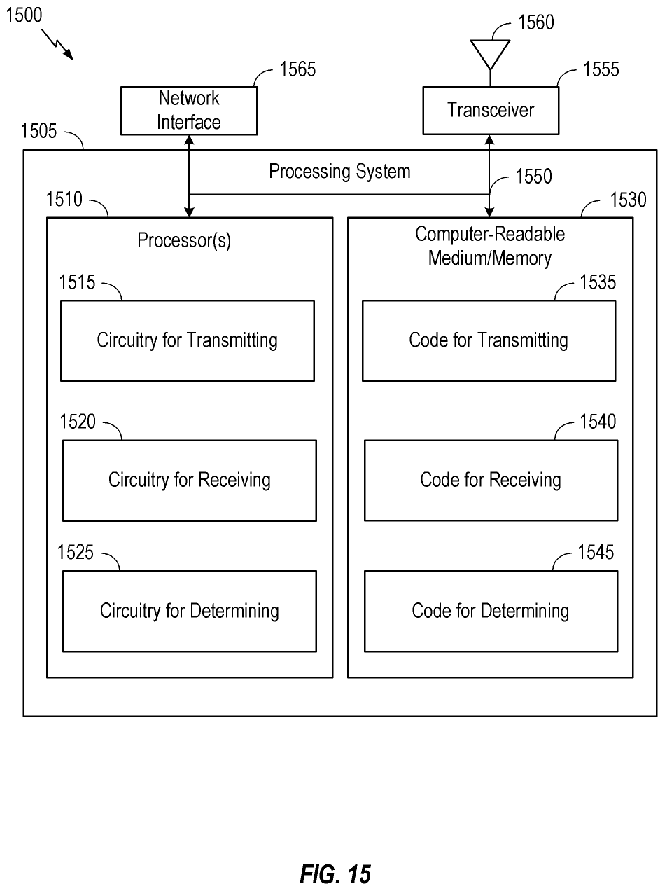

Method 1300 begins at step 1305 with transmitting a configuration for Doppler domain CSI reporting by a UE. In some cases, the operations of this step refer to, or may be performed by, circuitry for transmitting and/or code for transmitting as described with reference to FIG. 15.

Method 1300 then proceeds to step 1310 with transmitting a bundle of CSI-RS on a bundle of CSI-RS occasions. In some cases, the operations of this step refer to, or may be performed by, circuitry for transmitting and/or code for transmitting as described with reference to FIG. 15.

Method 1300 then proceeds to step 1315 with receiving, in accordance with the configuration, a report for Doppler domain CSI that includes parameters that indicate time domain variations of the measured CSI. In some cases, the operations of this step refer to, or may be performed by, circuitry for receiving and/or code for receiving as described with reference to FIG. 15.

In some aspects, the report parameters also indicate frequency domain variation of the measured.

In some aspects, the report also indicates the CSI-RS occasions that were measured and on which the report is based.

In some aspects, the report indicates: an average CQI that is an average of CQI calculated individually for the bundled CSI-RS occasions; and for each time and frequency CQI index associated with the report, a differential CQI term.

In some aspects, the differential CQI term represents a difference between the average CQI and a CQI calculated for the corresponding time and frequency CQI index.

In some aspects, the report indicates: a reference time block wideband CQI calculated for a reference time index; for each frequency CQI index associated with the report, a reference block subband CQI calculated based on the reference time block wideband CQI and a first differential term; and for each time CQI index associated with the report, a time block subband CQI calculated based on a block subband CQI and a second differential term.

In some aspects, the first differential term, for a corresponding frequency index, represents a difference between the reference time block wideband CQI and a CQI calculated for the reference time index and the corresponding frequency index.

In some aspects, the second differential term, for a corresponding frequency index and time index, represents a difference between a time block subband CQI calculated for the corresponding frequency index and a previous time index.

In some aspects, the report includes different second differential terms for different frequency indexes.

In some aspects, the report includes a common second differential term for different frequency indexes.

In some aspects, the method 1300 further includes determining a time grid size for the Doppler domain CSI in the report. In some cases, the operations of this step refer to, or may be performed by, circuitry for determining and/or code for determining as described with reference to FIG. 15.

In some aspects, the time grid size is determined based on a scaling factor and a parameter for generating the time grid size for time domain bundling CQI.

In some aspects, at least one of the scaling factor or parameter is configured by the network entity.

In some aspects, at least one of the scaling factor or parameter is reported by the UE to the network entity.

In some aspects, the configuration indicates whether the report is to be transmitted within a CSI-RS measurement time.

In some aspects, the report includes Doppler domain CSI with a first resolution when the report is transmitted within the CSI-RS measurement time; or the report includes Doppler domain CSI with a second resolution when the report is transmitted within the CSI-RS measurement time.

In some aspects, the first resolution corresponds to subband CQI in the report; and the second resolution corresponds to wideband CQI in the report.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to the transceiver 1465 (e.g., a transmitter and/or a receiver). The transceiver 1465 is configured to transmit and receive signals for the communications device 1400 via the antenna 1470, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1435 via a bus 1460. In certain aspects, the computer-readable medium/memory 1435 is configured to store instructions (e.g., computer-executable code) that when executed by the one or more processors 1410, cause the one or more processors 1410 to perform the method 1200 described with respect to FIG. 12, or any aspect related to it. Note that reference to a processor performing a function of communications device 1400 may include one or more processors 1410 performing that function of communications device 1400.

In the depicted example, computer-readable medium/memory 1435 stores code (e.g., executable instructions), such as code for receiving 1440, code for measuring 1445, code for transmitting 1450, and code for determining 1455. Processing of the code for receiving 1440, code for measuring 1445, code for transmitting 1450, and code for determining 1455 may cause the communications device 1400 to perform the method 1200 described with respect to FIG. 12, or any aspect related to it.

The one or more processors 1410 include circuitry configured to implement (e.g., execute) the code stored in the computer-readable medium/memory 1435, including circuitry such as circuitry for receiving 1415, circuitry for measuring 1420, circuitry for transmitting 1425, and circuitry for determining 1430. Processing with circuitry for receiving 1415, circuitry for measuring 1420, circuitry for transmitting 1425, and circuitry for determining 1430 may cause the communications device 1400 to perform the method 1200 described with respect to FIG. 12, or any aspect related to it.

Various components of the communications device 1400 may provide means for performing the method 1200 described with respect to FIG. 12, or any aspect related to it. For example, means for transmitting, sending or outputting for transmission may include transceivers 354 and/or antenna(s) 352 of the UE 104 illustrated in FIG. 3 and/or the transceiver 1465 and the antenna 1470 of the communications device 1400 in FIG. 14. Means for receiving or obtaining may include transceivers 354 and/or antenna(s) 352 of the UE 104 illustrated in FIG. 3 and/or the transceiver 1465 and the antenna 1470 of the communications device 1400 in FIG. 14.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1555 (e.g., a transmitter and/or a receiver) and/or a network interface 1565. The transceiver 1555 is configured to transmit and receive signals for the communications device 1500 via the antenna 1560, such as the various signals as described herein. The network interface 1565 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1530 via a bus 1550. In certain aspects, the computer-readable medium/memory 1530 is configured to store instructions (e.g., computer-executable code) that when executed by the one or more processors 1510, cause the one or more processors 1510 to perform the method 1300 described with respect to FIG. 13, or any aspect related to it. Note that reference to a processor of communications device 1500 performing a function may include one or more processors 1510 of communications device 1500 performing that function.

In the depicted example, the computer-readable medium/memory 1530 stores code (e.g., executable instructions), such as code for transmitting 1535, code for receiving 1540, and code for determining 1545. Processing of the code for transmitting 1535, code for receiving 1540, and code for determining 1545 may cause the communications device 1500 to perform the method 1300 described with respect to FIG. 13, or any aspect related to it.

The one or more processors 1510 include circuitry configured to implement (e.g., execute) the code stored in the computer-readable medium/memory 1530, including circuitry such as circuitry for transmitting 1515, circuitry for receiving 1520, and circuitry for determining 1525. Processing with circuitry for transmitting 1515, circuitry for receiving 1520, and circuitry for determining 1525 may cause the communications device 1500 to perform the method 1300 as described with respect to FIG. 13, or any aspect related to it.

Various components of the communications device 1500 may provide means for performing the method 1300 as described with respect to FIG. 13, or any aspect related to it. Means for transmitting, sending or outputting for transmission may include transceivers 332 and/or antenna(s) 334 of the BS 102 illustrated in FIG. 3 and/or the transceiver 1555 and the antenna 1560 of the communications device 1500 in FIG. 15. Means for receiving or obtaining may include transceivers 332 and/or antenna(s) 334 of the BS 102 illustrated in FIG. 3 and/or the transceiver 1555 and the antenna 1560 of the communications device 1500 in FIG. 15.

### Example Clauses

Implementation examples are described in the following numbered clauses:

Clause 1: A method for wireless communication by a UE, comprising: receiving, from a network entity, a configuration for Doppler domain CSI reporting; measuring CSI based on a bundle of CSI-RS occasions; and transmitting, in accordance with the configuration, a report for Doppler domain CSI that includes parameters that indicate time domain variations of the measured CSI.

Clause 2: The method of Clause 1, wherein the report parameters also indicate frequency domain variation of the measured.

Clause 3: The method of any one of Clauses 1 and 2, wherein the report also indicates the CSI-RS occasions that were measured and on which the report is based.

Clause 4: The method of any one of Clauses 1-3, wherein the report indicates: an average CQI that is an average of CQI calculated individually for the bundled CSI-RS occasions; and for each time and frequency CQI index associated with the report, a differential CQI term.

Clause 5: The method of Clause 4, wherein the differential CQI term represents a difference between the average CQI and a CQI calculated for the corresponding time and frequency CQI index.

Clause 6: The method of any one of Clauses 1-5, wherein the report indicates: a reference time block wideband CQI calculated for a reference time index; for each frequency CQI index associated with the report, a reference block subband CQI calculated based on the reference time block wideband CQI and a first differential term; and for each time CQI index associated with the report, a time block subband CQI calculated based on a block subband CQI and a second differential term.

Clause 7: The method of Clause 6, wherein: the first differential term, for a corresponding frequency index, represents a difference between the reference time block wideband CQI and a CQI calculated for the reference time index and the corresponding frequency index.

Clause 8: The method of Clause 7, wherein: the second differential term, for a corresponding frequency index and time index, represents a difference between a time block subband CQI calculated for the corresponding frequency index and a previous time index.

Clause 9: The method of Clause 8, wherein the UE calculates different second differential terms for different frequency indexes.

Clause 10: The method of Clause 8, wherein the UE calculates a common second differential term for different frequency indexes.

Clause 11: The method of any one of Clauses 1-10, further comprising: determining a time grid size for reporting the Doppler domain CSI.

Clause 12: The method of Clause 11, wherein the time grid size is determined based on a scaling factor and a parameter for generating the time grid size for time domain bundling CQI.

Clause 13: The method of Clause 12, wherein at least one of the scaling factor or parameter is configured by the network entity.

Clause 14: The method of Clause 12, wherein at least one of the scaling factor or parameter is reported by the UE to the network entity.

Clause 15: The method of any one of Clauses 1-14, wherein the configuration indicates whether the report is to be transmitted within a CSI-RS measurement time.

Clause 16: The method of Clause 15, wherein: the report includes Doppler domain CSI with a first resolution when the report is transmitted within the CSI-RS measurement time; or the report includes Doppler domain CSI with a second resolution when the report is transmitted within the CSI-RS measurement time.

Clause 17: The method of Clause 16, wherein: the first resolution corresponds to subband CQI in the report; and the second resolution corresponds to wideband CQI in the report.

Clause 18: A method for wireless communication by a network entity, comprising: transmitting a configuration for Doppler domain CSI reporting by a UE; transmitting a bundle of CSI-RS on a bundle of CSI-RS occasions; and receiving, in accordance with the configuration, a report for Doppler domain CSI that includes parameters that indicate time domain variations of the measured CSI.

Clause 19: The method of Clause 18, wherein the report parameters also indicate frequency domain variation of the measured.

Clause 20: The method of any one of Clauses 18 and 19, wherein the report also indicates the CSI-RS occasions that were measured and on which the report is based.

Clause 21: The method of any one of Clauses 18-20, wherein the report indicates: an average CQI that is an average of CQI calculated individually for the bundled CSI-RS occasions; and for each time and frequency CQI index associated with the report, a differential CQI term.

Clause 22: The method of Clause 21, wherein the differential CQI term represents a difference between the average CQI and a CQI calculated for the corresponding time and frequency CQI index.

Clause 23: The method of any one of Clauses 18-22, wherein the report indicates: a reference time block wideband CQI calculated for a reference time index; for each frequency CQI index associated with the report, a reference block subband CQI calculated based on the reference time block wideband CQI and a first differential term; and for each time CQI index associated with the report, a time block subband CQI calculated based on a block subband CQI and a second differential term.

Clause 24: The method of Clause 23, wherein: the first differential term, for a corresponding frequency index, represents a difference between the reference time block wideband CQI and a CQI calculated for the reference time index and the corresponding frequency index.

Clause 25: The method of Clause 24, wherein: the second differential term, for a corresponding frequency index and time index, represents a difference between a time block subband CQI calculated for the corresponding frequency index and a previous time index.

Clause 26: The method of Clause 25, wherein the report includes different second differential terms for different frequency indexes.

Clause 27: The method of Clause 25, wherein the report includes a common second differential term for different frequency indexes.

Clause 28: The method of any one of Clauses 18-27, further comprising: determining a time grid size for the Doppler domain CSI in the report.

Clause 29: The method of Clause 28, wherein the time grid size is determined based on a scaling factor and a parameter for generating the time grid size for time domain bundling CQI.

Clause 30: The method of Clause 29, wherein at least one of the scaling factor or parameter is configured by the network entity.

Clause 31: The method of Clause 29, wherein at least one of the scaling factor or parameter is reported by the UE to the network entity.

Clause 32: The method of any one of Clauses 18-31, wherein the configuration indicates whether the report is to be transmitted within a CSI-RS measurement time.

Clause 33: The method of Clause 32, wherein: the report includes Doppler domain CSI with a first resolution when the report is transmitted within the CSI-RS measurement time; or the report includes Doppler domain CSI with a second resolution when the report is transmitted within the CSI-RS measurement time.

Clause 34: The method of Clause 33, wherein: the first resolution corresponds to subband CQI in the report; and the second resolution corresponds to wideband CQI in the report.

Clause 35: An apparatus, comprising: a memory comprising executable instructions; and a processor configured to execute the executable instructions and cause the apparatus to perform a method in accordance with any one of Clauses 1-34.

Clause 36: An apparatus, comprising means for performing a method in accordance with any one of Clauses 1-34.

Clause 37: A non-transitory computer-readable medium comprising executable instructions that, when executed by a processor of an apparatus, cause the apparatus to perform a method in accordance with any one of Clauses 1-34.

Clause 38: A computer program product embodied on a computer-readable storage medium comprising code for performing a method in accordance with any one of Clauses 1-34.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communication by a user equipment (UE), comprising:
receiving, from a network entity, a configuration for Doppler domain channel state information (CSI) reporting;
measuring channel state information (CSI) based on a bundle of CSI reference signal (CSI-RS) occasions; and
transmitting, in accordance with the configuration, a report for Doppler domain CSI that includes parameters that indicate time domain variations of the measured CSI.

2. The method of claim 1, wherein the parameters also indicate frequency domain variation of the measured CSI.

3. The method of claim 1, wherein the report also indicates the CSI-RS occasions that were measured and on which the report is based.

4. The method of claim 1, wherein report indicates:
an average channel quality indicator (CQI) that is an average of CQI calculated individually for the bundled CSI-RS occasions; and
for each time and frequency CQI index associated with the report, a differential CQI term.

5. The method of claim 4, wherein the differential CQI term represents a difference between the average CQI and a CQI calculated for a corresponding time and frequency CQI index.

6. The method of claim 1, wherein the report indicates:
a reference time block wideband channel quality indicator (CQI) calculated for a reference time index;
for each frequency CQI index associated with the report, a reference block subband CQI calculated based on the reference time block wideband CQI and a first differential term; and
for each time CQI index associated with the report, a time block subband CQI calculated based on a block subband CQI and a second differential term.

7. The method of claim 6, wherein:
the first differential term, for a corresponding frequency index, represents a difference between the reference time block wideband CQI and a CQI calculated for the reference time index and the corresponding frequency index.

8. The method of claim 7, wherein:
the second differential term, for a corresponding frequency index and time index, represents a difference between a time block subband CQI calculated for the corresponding frequency index and a previous time index.

9. The method of claim 8, wherein the UE calculates different second differential terms for different frequency indexes.

10. The method of claim 8, wherein the UE calculates a common second differential term for different frequency indexes.

11. The method of claim 1, further comprising determining a time grid size for reporting the Doppler domain CSI.

12. The method of claim 11, wherein the time grid size is determined based on a scaling factor and a parameter for generating the time grid size for time domain bundling CQI.

13. The method of claim 12, wherein at least one of the scaling factor or parameter is configured by the network entity.

14. The method of claim 12, wherein at least one of the scaling factor or parameter is reported by the UE to the network entity.

15. The method of claim 1, wherein the configuration indicates whether the report is to be transmitted within a CSI-RS measurement time.

16. The method of claim 15, wherein:
the report includes Doppler domain CSI with a first resolution when the report is transmitted within the CSI-RS measurement time; or
the report includes Doppler domain CSI with a second resolution when the report is transmitted within the CSI-RS measurement time.

17. The method of claim 16, wherein:
the first resolution corresponds to subband channel quality indicator (CQI) in the report; and
the second resolution corresponds to wideband CQI in the report.

18. A method for wireless communication by a network entity, comprising:
transmitting a configuration for Doppler domain channel state information (CSI) reporting by a user equipment (UE);
transmitting a bundle of channel state information (CSI) reference signals (CSI-RS) on a bundle of CSI-RS occasions; and
receiving, in accordance with the configuration, a report for Doppler domain CSI that includes parameters that indicate time domain variations of measured CSI.

19-38. (canceled)

39. A user equipment (UE), comprising:
one or more memories comprising executable instructions; and
one or more processors individually or collectively configured to execute the executable instructions to cause the UE to:
receive, from a network entity, a configuration for Doppler domain channel state information (CSI) reporting;
measure channel state information (CSI) based on a bundle of CSI reference signal (CSI-RS) occasions; and
transmit, in accordance with the configuration, a report for Doppler domain CSI that includes parameters that indicate time domain variations of the measured CSI.
